(19) United States
(12) Patent Application Publication
(10) Pub. No.: US 2014/0267742 A1
(43) Pub. Date: Sep. 18, 2014

(54) CAMERA WITH REMOTE WATCH

(71) Applicants: William F. Tapia, Weston, FL (US); Benjamin Pei-Ming Chia, Cupertino, CA (US); Stephen Hooper, Bellingham, WA (US); Yi-Chun Liao, Taichung City (TW)

(72) Inventors: William F. Tapia, Weston, FL (US); Benjamin Pei-Ming Chia, Cupertino, CA (US); Stephen Hooper, Bellingham, WA (US); Yi-Chun Liao, Taichung City (TW)

(21) Appl. No.: 13/839,792

(22) Filed: Mar. 15, 2013

(51) Int. Cl. H04N 7/18

(52) U.S. Cl. CPC H04N 7/183
USPC 348/157

(57) ABSTRACT

Systems and processes for communicating a surfing experience includes capturing preview pictures or videos using a camera mounted on a surfer's head or a surfboard; displaying the preview pictures or videos on a remote watch; adjusting the camera's angle or position based on the preview pictures or videos; and storing pictures or videos into a camera memory during a surf session.

This application is related to application Ser. No. ______, all filed concurrently herewith, the contents of which are incorporated by reference.

### BACKGROUND

This application relates to remote control of cameras.

Surfing is the movement of a board through the face of a wave. One of the goals of surfing is to get as deep into the barrel of the wave as possible or just get a good long ride. Some people treat a wave as a ramp to do tricks and some simply just ride the waves. The reason why people surf is the feeling or adrenaline rush that comes after riding the face of the wave.

Surfers are proud of their achievements and want to share their experience with others in the surfing community. Since the beginning of photography, surfers have faced the problem of conveniently carrying, accessing, and using a camera under various operating conditions. Low cost digital cameras have been put in waterproof housing and secured using various mounts, harnesses, or straps to allow a user to keep one or more hands free for the physical activity. For example, camera wrist strap can be used to allow the user to easily access, operate, and then quickly secure the camera. However, such wrist strap is not practical for photography or videography during surfing. Alternatively, helmet style camera systems allow a user to mount a compact and lightweight camera to a helmet. However, these helmets are designed for biking or snowboarding where waterproofing is not an issue and, moreover, helmets are not commonly used in surfing and thus are not preferred by surfers.

Additionally, these camera systems often lack features available in more traditional cameras. For example, wrist-mounted or helmet mounted camera systems often lack display screens in order to keep the camera systems small, lightweight, and low cost. While features such as a display screen may be desirable in some scenarios, it may not be useful in others scenarios. For example, a display screen would not be useful when the camera is mounted to a helmet, but may be useful when the camera is strapped to a wrist. However, for surfing, taking images from the wrist is not as stable as on the forehead, so wrist-cameras are not popular in surfing videography or photography.

### SUMMARY

Systems and processes for communicating a surfing experience includes capturing preview pictures or videos using a camera mounted on a surfer's head or a surfboard; displaying the preview pictures or videos on a remote watch; adjusting the camera's angle or position based on the preview pictures or videos; and storing pictures or videos into a camera memory while surfing.

Implementations of the above aspect may include one or more of the following. A wireless link can be established between the camera and the remote watch. The system can transfer compressed images or videos from the camera to the remote watch and decompress the images or videos for display on the remote watch. The remote watch can turn the camera recording on and off. The camera can constantly capture images and the remote can select and save a predetermined image. The camera body can be a curved anatomical shape to be secured to a forehead. The camera can be placed into a headband and secured onto the surfer's head. The headband can be a bandana, wherein the camera is magnetically positioned to a front portion of the bandana. The camera can be mounted to the surfboard, and the user can preview an image or video on the remote watch and adjust the camera position to take a desired image or video. The method can include uploading the pictures or videos from the camera to a remote host computer; creating at least one collage from the pictures or videos, wherein items in the collage are variably sized based on one or more predetermined factors; and sharing the collage with at least another user.

Advantages of the preferred embodiments may include one or more of the following. The system allows users to preview images and take better pictures and videos. This is important as the user has only one chance to record a surf run, and if the camera orientation or angle is off, the video or picture will be unusable. The system is also cost-effective, as only those users who need to preview need to buy both the camera and the remote. Moreover, the combination is flexible and can work with different camera models so users can mix and match. The camera system produces high quality video data, requires less storage capacity and network bandwidth, is easily scalable, and operates for a longer period of time without storage device replacement. The processor can generate metadata with the video that can be made into content-aware video for ease of searching. The content-aware video data storage system includes video analytics that analyzes the content of the video data and local video data stores that store portions of the video data in response to the analysis by the video analytics. Video data corresponding to the portions of video data are delivered through the network communication paths to the network video data stores to provide a managed amount of video data representing at a specified quality level the fields of view of the scenes. The managed amount of the video data consumes substantially less network bandwidth and fewer data storage resources than those which would be consumed by delivery to the network video stores the video data produced by the network video imaging devices at the specified quality level and in the absence of analysis by the video analytics. While video surveillance applications are of particular interest, the above approach is applicable across a wide variety of video applications.

Additional aspects and advantages will be apparent from the following detailed description of preferred embodiments, which proceeds with reference to the accompanying drawings.

### BRIEF DESCRIPTION OF THE DRAWINGS

The disclosed embodiments have other advantages and features which will be more readily apparent from the following detailed description and the appended claims, when taken in conjunction with the accompanying drawings, in which:

FIG. 1 shows an exemplary process for using a camera with a remote watch.

FIGS. 2A-2B show front and back views of the exemplary watch, while FIGS. 2C-2D show exemplary remote operation user interfaces.

FIG. 3A shows various options for the camera and remote watch.

FIG. 3B show one exemplary watch embodiment with front view and back view and a wristband color option.

FIG. 3C shows exemplary user interface modes controlled using the wristwatch of FIG. 3B.

FIG. 4 shows an exemplary camera that can be head-mounted or surfboard mounted.

FIG. 5 shows an exemplary surfboard mounted camera configuration.

FIGS. 6A-6B show an exemplary camera housing bandana configuration.

FIGS. 7A-7B show another headmount embodiment, but with a head strap and a sunshield or visor that can be optionally mounted on the headmount.

FIG. 7C shows another camera embodiment with wide angle lens and a lanyard or carabiner securing system.

FIG. 8A shows an exemplary digital camera schematic.

FIG. 8B shows an exemplary remote watch schematic.

### DETAILED DESCRIPTION

FIG. 1 shows an exemplary process 102 for using a camera 300 with a remote watch 400. In this process, a user wears both devices in 104. The remote is used to adjust the camera angle in 106. The user can command the camera 300 to take a picture and display a preview on the watch 400 in 108. Based on the preview, the user can adjust the angle and direction of the camera 300 in 110. To confirm the setting, the user can take a second preview with a screenshot to confirm the correct angle and direction of the camera in 112.

FIG. 2A-2B show front and back views of the exemplary watch 400. The watch 400 has a face 402 with a display screen that can show a preview of an image taken by the camera 300. The watch 400 has a plurality of pushbutton inputs. The face 402 has a wristband receptacle 406 through which a wristband 404 can be threaded there through and secured to the user's wrist or ankle or any other suitable body placement.

The display screen on the face 402 can also provide feedback on various modes of operations such as record/stop, time information, screenshot, and pairing for remote data communication, as shown in the embodiments of FIGS. 2C and 2D.

FIG. 3A shows various options for the camera and remote watch. The camera can be head-mounted using a bandana or can be surfboard mounted using a surfboard mounting base. The watch can have a variety of colors, with matching color carrying bands, for example. FIG. 3B show one exemplary watch embodiment with front view and back view and a wristband color option. FIG. 3C shows exemplary user interface modes controlled using the wristwatch of FIG. 3B. Further, as shown in FIG. 3B, a watch band color insert can be used to provide additional color options for the watch wristband.

FIG. 4 shows an exemplary camera with a curved body 300 that can be head-mounted or surfboard-mounted. Although the disclosed embodiments secure a camera for surfing purposes, the camera can be used in various sports including sports that use a board, for example a surfboard, windsurfing board, kite surfing board, skateboard, snowboard, skis, or a wakeboard. The head-mounted camera is also useful for any type of sports including skiing, snowboarding, horse riding, snorkeling, skiing, mountain biking, kayaking, and rafting, among others. For ease of description, references will be made to a surfing, but the principles described herein are understood to be applicable to other sports.

The camera includes a moveable arm 310 that rotates out to expose one or more connectors 312 on either side of the camera body. The arm 310 can be a side rubber strip or other suitable materials that provide a seal or waterproof protection for the connectors 312 when the arm 310 is closed. The arm also allows the camera to stand on a desktop. The camera 300 has a lens 314 that is optimized for capturing surfing images or videos. In one embodiment, the lens 314 is fixed, and in another embodiment, a servomotor can adjust the focus for improved sharpness. In one embodiment, the camera can have two images to capture stereo or 3D images of the surfing experience. One or more buttons 316 is positioned on the body 300 to allow the user to control the camera such as to start and stop recording videos, among others. One or more openings 319 are positioned at each corner of the camera body 300 to allow the user to see the outputs of display devices such as LED displays. These displays may be turned on in a predetermined sequence to indicate that filming is on or that a setting has been selected, for example. A ring 318 is positioned at one end of the lens for subsequent attachment to a helmet, head band, or bandana to secure the camera to the head. Such helmets and bandanas require no effort in carrying the camera and are convenient for surfers to use while securing the camera to the surfer.

FIG. 5 shows a surf-board mounted camera. Although the disclosed embodiments include a mount for attaching a camera to a sporting board, for example a surfboard, windsurfing board, kite surfing board, skateboard, snowboard, skis, or a wakeboard. For ease of description, references will be made to a surfboard, but the principles described herein are understood to be applicable to other sporting boards.

Turning now to FIG. 5, the camera body 300 is inside of a protective enclosure 330 that provides an access port to the lens 314 and button 316, among others. The protective enclosure 330 has an attachment base 328 that is suitably hingedly connected to an elevation adjustment structure 326 which is surrounded by buttons 324 and positioned on a post 322. To adjust the elevation of the camera, the user pushes down on the adjustment structure 326. To tilt the camera, the user squeezes the buttons 324 and tilts the camera body 300. The unit can be flipped back to aim at the surfer. The post 322 is mounted on top of a base 320 and rotates on the base 320 to prevent scratching the surfboard. Once mounted, the camera can point in the same direction as the surfer's view, or alternatively can point the other way to capture images of the surfer.

In various embodiments, the camera mount can be placed on the front of the surfboard or the rear of the surfboard. Furthermore, the mount can be configured to face either forwards or backwards to capture images and/or video from different viewpoints while surfing. Moreover, the mount can include a pivoting joint to allow a user to rotate the camera either upward or downward and then secure the camera at a fixed angle to capture images and/or video from different angles. Beneficially, the camera mount allows a user to securely, safely, and easily carry a camera while surfing in a manner which does not handicap the user's participation in surfing.

Turning now to FIGS. 6A-6B, a wearable camera mount system is shown. The bandana has a front portion 340 that is rotatably connected to a rear portion 342 at a joint with a pivot pin 344. The front portion 340 has extension arms 342 to allow the user to select the appropriate hole in the extension arm and adjust the size of the bandana to snugly fit the user's head. The front portion 340 has an opening to receive the camera lens 314 and a magnetic ring 348 that securely engages the ring 318 on the camera body 300. One or more pushbuttons 346 are provided on the front portion 340 that, when pushed by the user, makes mechanical contact with the corresponding pushbuttons 316 on the camera body 300.

FIGS. 7A-7B show another headmount embodiment, but with a head strap and a sunshield or visor that can be optionally mounted on the headmount. FIG. 7C shows another camera embodiment with wide angle lens and a lanyard or carabiner securing system.

Once the camera has been secured to the bandana, the bandana takes seconds to wear and adjust, yet it can support the camera in the perfect position for the entire surfing session, helping surfers to take great still and motion photography by preventing camera movement. The head-worn camera minimizes any camera movement while the shutter is open to reduce a blurred image. In the same vein, the bandana reduces camera shake, and thus are instrumental in achieving maximum sharpness.

The head-mount system allows a user to securely mount a camera to the head to capture images and/or video during activity involving the user without taking away from the user's ability to surf or participate in other similar activities. Beneficially, the mount provides a solid platform projecting from the user's head in a variety of positions and angles to allow for the capture of images (still and/or video) from the perspective of the surfer without camera shaking or other instability when taking videos.

In one embodiment, the bandana is a two-piece assembly, with a front portion 340 having an opening to receive the camera lens 314. Each portion can be molded from a single piece of flexible material containing a plurality of rigid elements integrally carried therein. The flexible multi-piece (such as 2, 3 or 4 pieces) bandana elements deform independently of each other to the extent required to conform to the wearer's head. The bandana is easily and inexpensively manufactured in a variety of forms to meet certain functional and esthetic requirements. In other embodiments, instead of a bandana, a baseball cap, hood, or other close fitting clothing can be used.

FIG. 8A shows an exemplary camera schematic. A processor 502 communicates over a bus with memory such as RAM 504 and ROM 506. The processor (CPU) 502 also communicates with a USB transceiver 508 to allow the user to transfer data from memory to a remote computer. The processor 502 also communicates with a wireless transceiver 510 such as Bluetooth to allow wireless data transfer with the remote phone, tablet or computer. In one embodiment, the camera is completely sealed to provide waterproofing. In another embodiment, the camera has a flash memory receptacle 507 that allows common flash modules to be inserted into the camera to provide high capacity video storage and expandability. The CPU 502 also controls a servo motor 512 to adjust the focus of the lens 318. Light captured by an image sensor 500 is processed by the CPU 502. Additionally, one or more displays 514 can be driven by the CPU 502. In one embodiment, the displays 514 can be LEDs positioned at four corners of the camera to provide visual feedback to the surfer. In another embodiment, an OLED display can be provided to show the user the image or video being captured.

The image sensor 500 can be a charge coupled device (CCD) or a complementary metal oxide semiconductor (CMOS) device. Both CCD and CMOS image sensors convert light into electrons. Once the sensor converts the light into electrons, it reads the value (accumulated charge) of each cell in the image. A CCD transports the charge across the chip and reads it at one corner of the array. An analog-to-digital converter (ADC) then turns each pixel's value into a digital value by measuring the amount of charge at each photo site and converting that measurement to binary form. CMOS devices use several transistors at each pixel to amplify and move the charge using more traditional wires. The CPU 502 can be a low power processor such as an ARM processor and can run Android as an embedded operating system in one embodiment.

The camera body 300 may also include a battery to supply operating power to components of the system including the processor, ROM/RAM, flash memory, input device, microphone, audio transducer, H.264 media processing system, and sensor(s) such as accelerometers and GPS unit.

The processor controls the image processing operation; and, it controls the storage of a captured image in storage device such as RAM or flash. The processor also controls the exporting of image data (which may or may not be color corrected) to an external general purpose computer or special purpose computer. The processor also responds to user commands (e.g., a command to “take” a picture or capture video by capturing image(s) on the image sensor and storing the image(s) in memory or a command to select an option for contrast enhancement and color balance adjustment). Such commands may be verbal and recognized through speech recognition software, or through the remote watch 400.

In one embodiment, the processor can be an ARM processor with integrated graphical processing units (GPUs). The GPUs can perform panorama stitching so that 3 inexpensive cameras can be used to provide a 180 degree immersive view.

In some embodiments, the processor is configured to continuously capture a sequence of images; to store a predetermined number of the sequence of images in a buffer, to receive a user request to capture an image; and to automatically select one of the buffered images based on an exposure time of one of the buffered images. The sequence of images may be captured prior to or concurrently with receiving the user request. The processing system while automatically selecting one of the buffered images is further configured to determine an exposure time of one of the buffered images, determine whether the exposure time meets predetermined criteria based on a predetermined threshold exposure time, and select the most recent image if the exposure time meets the predetermined criteria. The processing system is also configured to initiate the continuously capturing and the storing after the data processing system enters an image capture mode. While automatically selecting one of the buffered images, the processor can determine a focus score for each buffered image and to select a buffered image based on the focus score if the exposure time fails to meet the predetermined criteria. The processing system while selecting a buffered image based on the focus score is further configured to determine a product of the focus score and the weighted factor for each of the buffered images and select a buffered image having a highest product if the exposure time fails to meet the predetermined criteria.

FIG. 8B shows an exemplary wristwatch schematic. A processor 552 communicates over a bus with memory such as RAM 554 and ROM 556. The processor (CPU) 552 also communicates with a USB transceiver 558 to allow the user to transfer data from memory to a remote computer. The USB port can also be used for charging a battery that powers the watch. The processor 552 also communicates with a wireless transceiver 560 such as Bluetooth to allow wireless data transfer with the camera's processor 502. A display 564 can be driven by the CPU 502. In one embodiment, the display 564 can be an OLED display to show the user the image or video being captured by the image sensor 500, for example.

The wristwatch and the camera can use H.264 encoder and decoder to compress the video transmission between the units. H.264 encoding can be essentially divided into two independent processes: motion estimation and compensation, and variable length encoding. The motion estimation sub module of the core consists of two stages: integer pixel motion estimation followed by a refining step that searches for matches down to ¼ pixel resolution. The integer search unit utilizes a 4 step search and sums of absolute difference (SAD) process to estimate the motion vector. Similar to the case of motion estimation, SADs are used to search for the intra prediction mode that best matches the current block of pixels. The resultant bitstream is assembled into NAL units and output in byte stream format as specified in Annex B of the ITU-T H.264 specification. In the encoder, the initial step is the generation of a prediction. The baseline H.264 encoder uses two kinds of prediction: intra prediction (generated from pixels already encoded in the current frame) and inter prediction (generated from pixels encoded in the previous frames). A residual is then calculated by performing the difference between the current block and the prediction. The prediction selected is the one that minimizes the energy of the residual in an optimization process that is quite computationally intensive. A linear transform is then applied to the residual. Two linear transforms are used: Hadamard and a transform derived from the discrete cosine transform (DCT). The coefficients resulting from the transformations are then quantized, and subsequently encoded into Network Abstraction Layer (NAL) units. These NALs include context information—such as the type of prediction—that is required to reconstruct the pixel data. The NAL units represent the output of the baseline H.264 encoding process. Meanwhile, inverse quantization and transform are applied to the quantized coefficients. The result is added to the prediction, and a macroblock is reconstructed. An optional deblocking filter is applied to the reconstructed macroblocks to reduce compression artifacts in the output. The reconstructed macroblock is stored for use in future intra prediction and inter prediction. Intra prediction is generated from unfiltered reconstructed macroblocks, while inter prediction is generated from reconstructed macroblocks that are filtered or unfiltered. Intra prediction is formed from pixels that were previously encoded. Two kinds of intra predictions are used: intra16×16 and intra4×4. In intra16×16, all the pixels already encoded at the boundary with the current block can be used to generate a prediction. These are shown shaded in the figure below. The core can generate the four modes of the intra16×16 prediction. In intra4×4, 16 4×4 blocks of prediction are generated from the pixels at the boundaries of each 4×4 prediction block and boundary pixels are used in intra16×16 and intra4×4 intra prediction modes. The inter prediction is generated from motion estimation. At the heart of video compression, motion estimation is used to exploit the temporal redundancy present in natural video sequences. Motion estimation is performed by searching for a 16×16 area of pixels in a previously encoded frame so that the energy of the residual (difference) between the current block and the selected area is minimized. The core can search an area 32×32 pixels wide, down to ¼ pixel of resolution (−16.00, +15.75 in both X and Y direction). Pixels at ¼ resolution are generated with a complex interpolation filter described in the ITU-T H.264 specification. The Hadamard transform and an integer transform derived from the DCT and their descriptions can be found in the ITU-T H.264 standard, the content of which is incorporated by reference. Both transforms (and their inverse functions) can be performed by using only additions, subtractions and shift operations. Both quantization and its inverse are also relatively simple and are implemented with multiplication and shifts.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure. Those of skill in the art will understand the wide range of structural configurations for one or more elements of the present invention. For example, certain elements may have square or rounded edges to give it a particular look. Further, particular elements of the present invention that are joined or attached to one another in the assembly process can be made, molded, machined, or otherwise fabricated as a single element or part. In addition, certain elements of the present invention that are fabricated as a single element or part can be fabricated as separate elements or in a plurality of parts that are then joined or otherwise attached to one another in the assembly process. Certain elements of the present invention that are made of a particular material can be made of a different material to give the device a different appearance, style, weight, flexibility, rigidity, reliability, longevity, ease of use, cost of manufacture, among others.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention.

While the above description contains much specificity, these should not be construed as limitations on the scope, but rather as an exemplification of preferred embodiments thereof. Accordingly, the scope of the disclosure should be determined not by the embodiment(s) illustrated, but by the appended claims and their legal equivalents.

What is claimed is:

1. A process for communicating a surfing experience, comprising:
capturing preview pictures or videos using a camera mounted on a surfer's head or a surfboard;
displaying the preview pictures or videos on a remote watch;
adjusting the camera's angle or position based on the preview pictures or videos; and
storing pictures or videos into a camera memory while surfing.

2. The process of claim 1, comprising establishing a wireless link between the camera and the remote watch.

3. The process of claim 1, comprising transferring compressed images or videos from the camera to the remote watch and decompressing the images or videos for display on the remote watch.

4. The process of claim 1, comprising using the remote watch to turn recording on and off.

5. The process of claim 1, comprising constantly capturing images and using the remote to save a predetermined image.

6. The process of claim 1, wherein the camera body comprises an anatomical shape to be secured to a surfer's head.

7. The process of claim 1, comprising mounting a camera into a headband and securing the headband onto the surfer's head.

8. The process of claim 7, wherein the headband comprises a bandana, comprising magnetically attaching the camera to a front portion of the bandana.

9. The process of claim 1, wherein the camera is mounted to the surfboard, comprising previewing an image or video on the remote watch and adjusting the camera position to take a desired image or video.

10. The process of claim 1, comprising watching video on display on a board mount.

11. The process of claim 1, comprising recording in 3D.

12. The process of claim 1, comprising:
uploading the pictures or videos from the camera to a remote host computer;
creating at least one collage from the pictures or videos, wherein items in the collage are variably sized based on one or more predetermined factors; and
sharing the collage with at least another user.

13. A system for communicating a surfing experience, comprising:
a camera mounted on a surfer's head or a surfboard to capture a preview picture or video;
a remote watch wirelessly coupled to the camera to display the preview picture or video;
adjusting the camera's angle or position based on the preview pictures or videos; and
storing pictures or videos into a camera memory during a surf session.

14. The system of claim 13, comprising a wireless link between the camera and the remote watch.

15. The system of claim 13, wherein the camera comprises a low profile board mounted camera.

16. The system of claim 12, wherein the wireless link transfers compressed images or videos from the camera to the remote watch and decompressing the images or videos for display on the remote watch.

17. The system of claim 13, wherein the remote watch turns recording on the camera on and off.

18. The system of claim 13, comprising computer code for constantly capturing images and using the remote to save a predetermined image.

19. The system of claim 13, wherein the camera body comprises a anatomical shape to be secured to a surfer's head.

20. The system of claim 13, comprising mounting a camera into a headband and securing the headband onto the surfer's head.

21. The system of claim 20, wherein the headband comprises a bandana, comprising a magnetic ring to attach the camera to a front portion of the bandana.

22. The system of claim 13, comprising wherein the camera is mounted to the surfboard, comprising computer code to preview an image or video on the remote watch and adjust the camera position to take a desired image or video.

23. The system of claim 13, comprising a server to receive the pictures or videos from the camera to the server, further comprising code for:
creating at least one collage from the pictures or videos, wherein items in the collage are variably sized based on one or more predetermined factors; and
sharing the collage with at least another user.
